(19) United States
(12) Patent Application Publication
(10) Pub. No.: US 2012/0307310 A1
(43) Pub. Date: Dec. 6, 2012

(54) IMAGE FORMING APPARATUS, METHOD FOR DATA MANAGEMENT, AND STORAGE MEDIUM

(75) Inventor: Yasunori Kanai, Tokyo (JP)

(73) Assignee: CANON KABUSHIKI KAISHA, Tokyo (JP)

(21) Appl. No.: 13/480,264

(22) Filed: May 24, 2012

(30) Foreign Application Priority Data
May 30, 2011 (JP) 2011-120508

(51) Int. Cl. G06K 15/02

(52) U.S. Cl. 358/1.16

(57) ABSTRACT

While one print job is in process, a determination is made whether reusable data reusable by another print job is under access control. If the reusable data is determined to be under access control, the reusable data is stored such that it is not reusable by another print job. If the reusable data is determined not to be under access control, the reusable data is stored such that it is reusable by another print job, and an image formed using the stored reusable data.

### BACKGROUND OF THE INVENTION

1. Field of the Invention

The present invention relates to an image forming apparatus, a method for data management, and a storage medium.

2. Description of the Related Art

Variable data printing (VDP), a digital printing technology for printing data according to each customer's needs, has recently been growing in demand. For VDP, standards (VDP languages) such as Personalized Print Markup Language (PPML) and Portable Document Format/Variable and Transactional (PDF/VT) have been developed. According to the VDP languages, objects included in print data can be classified into a reuse object that is to be reused and an object that is not. The VDP languages can also be used to design so that rasterized image data on reuse objects can be cached and reused for subsequent use. In other words, one of the features of the VDP languages is that the number of rasterization operations can be reduced for faster print processing.

In PPML, one of the VDP languages, reuse objects are referred to as reusable objects. Other objects are referred to as variable objects. Japanese Patent Application Laid-Open No. 2009-301426 discusses the following technology. Reusable objects have their range of reusability (i.e., an effective range). Regarding a reusable object, rasterized image data on the reusable object is stored in a cache. The stored image data is reused within the effective range. The image data is discarded from the cache when the effective range is exceeded.

There is a special reusable object referred to as a global reusable object. A global reusable object has no effective range defined. Image data on a global reusable object will not be discarded from a cache unless a particular operation, such as an explicit instruction from the user, is made, so that the global reusable object can thus be used as an always usable object.

Variable printing may handle confidential information such as a user's name, address, and personalized goods. Variable printing may thus use print data, some or all of which is put under access control (for example, an encrypted PDF file). In variable printing, a user generally does not specify reusable objects and global reusable objects. Such object classifications are automatically added by a print application for generating print data according to an object layout and various settings.

A print application may set an object of a PDF file under access control as a global reusable object. When a conventional printing apparatus receives print data that is set thus, the printing apparatus performs access authentication based on a user-input password. If authenticated, the printing apparatus stores rasterized image data into a cache and reuses the image data within a job. Note that such image data and other reusable data are cached without access control despite the access control on the object of the PDF file. The resulting reusable data can be reused by any job, which gives rise to a security issue.

### SUMMARY OF THE INVENTION

One aspect of the present invention is directed to managing reusable data more appropriately.

According to an aspect of the present invention, an image forming apparatus includes a memory, a processor, connected to the memory, the processor configured to determine, while a first job is in process, whether reusable data reusable by a second job different from the first job is under access control, wherein the processor is further configured to, if the reusable data is determined to be under access control, store the reusable data such that it is not reusable by another job, and to store the reusable data such that it is reusable by another job if the reusable data is determined not to be under access control, and an image forming unit configured to form an image using the stored reusable data.

According to embodiments of the present invention, reusable data can be managed more appropriately.

Further features and aspects of the present invention will become apparent from the following detailed description of exemplary embodiments with reference to the attached drawings.

### BRIEF DESCRIPTION OF THE DRAWINGS

The accompanying drawings, which are incorporated in and constitute a part of the specification, illustrate exemplary embodiments, features, and aspects of the invention and, together with the description, serve to explain the principles of the invention.

FIG. 1 illustrates an example of a configuration of a printing apparatus.

FIG. 2 illustrates an example of software modules.

FIG. 3 illustrates an example of a configuration of VDP data.

FIGS. 4A and 4B illustrate an example of print results and an example of raster image processor (RIP) processing time.

FIG. 5 illustrates an example of a flowchart for print processing.

FIG. 6 illustrates an example of a flowchart for cache processing.

FIG. 7 illustrates an example of a flowchart for cache processing.

FIG. 8 illustrates an example of a flowchart for cache processing.

### DESCRIPTION OF THE EMBODIMENTS

Various exemplary embodiments, features, and aspects of the invention will be described in detail below with reference to the drawings.

### <Configuration of Printing Apparatus>

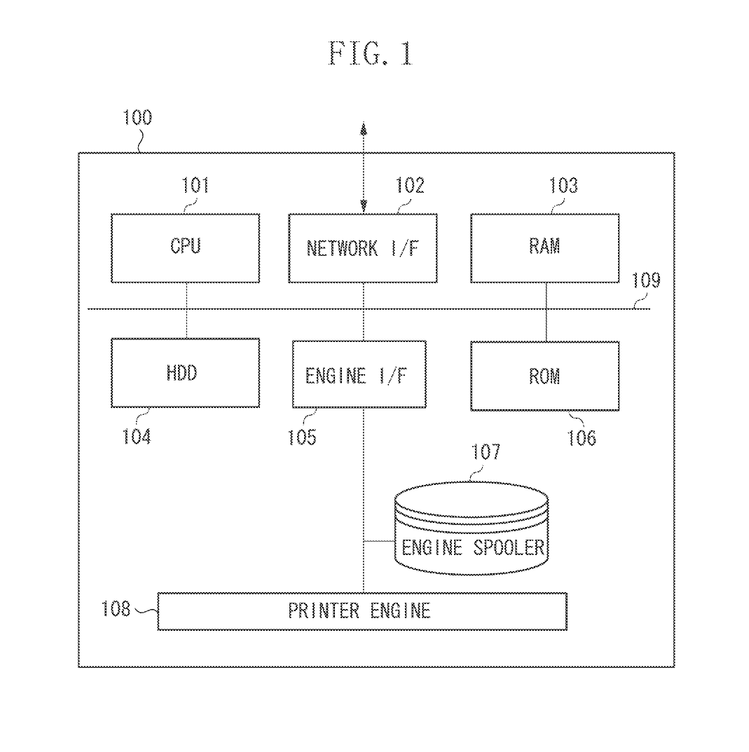

FIG. 1 illustrates an example of the configuration of a printing apparatus 100 that performs variable printing according to a first exemplary embodiment. The printing apparatus 100 is an example of an image forming apparatus (computer), such as a color printer or a multifunction peripheral. A central processing unit (CPU) 101 is an example of a central arithmetic device. The CPU 101 governs control and operation of various components in the printing apparatus 100 and execution of programs stored in storage units, as described below, via a system bus 109.

A random access memory (RAM) 103 is an example of a storage unit. The RAM 103 is used as a temporary storage area and a work memory when the printing apparatus 100 is in operation. A hard disk drive (HDD) 104 is an example of amass storage unit. The HDD 104 stores various types of programs to be executed by the CPU 101. The HDD 104 is also used as a temporary storage area of data to be processed.

A read-only memory (ROM) 106 stores a start processing program of the printing apparatus 100. A network interface (I/F) 102 performs communication with other apparatuses, such as a host computer, via an external network.

An engine interface (I/F) 105 governs communication and control of a printer engine 108. The printer engine 108 is a device that forms an image on a sheet using an electrophotographic technique and/or an inkjet image forming technique. The printer engine 108 includes an engine spooler 107, which temporarily stores page data transferred from the engine interface 105.

### <Configuration of Software Modules>

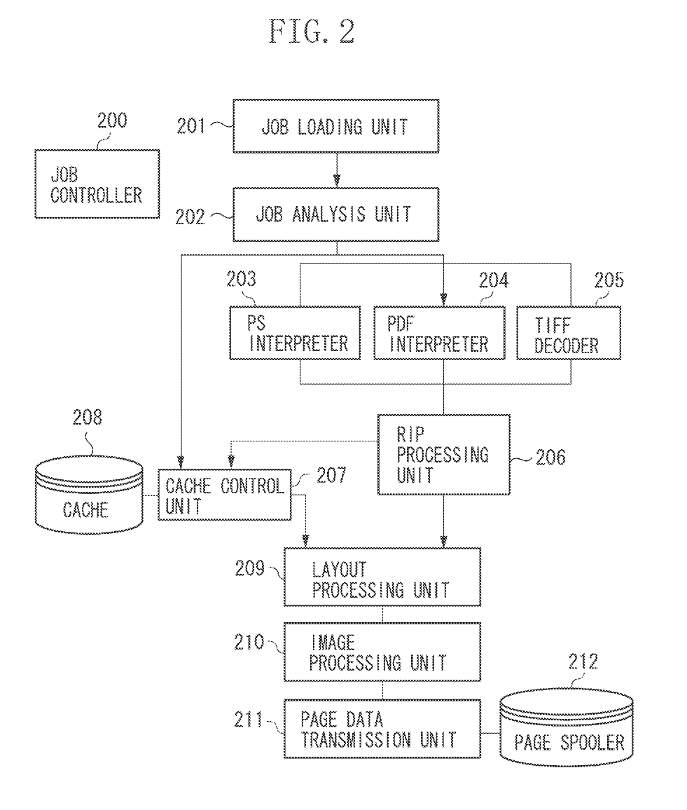

FIG. 2 illustrates an example of software modules for executing variable printing. The software modules are each implemented by the CPU 101 loading a program stored in the HDD 104 or the ROM 106 into the RAM 103 and executing the same. Functions of the printing apparatus 100 and processing according to the flowcharts described below are carried out by the software modules. However, some or all of the functions of the printing apparatus 101 and/or the processing according to the flowcharts described below may be implemented by dedicated hardware.

A job controller 200 controls other software modules and performs a master control function. A job loading unit 201 loads VDP data (job) used in variable printing, received via the network I/F 102. Hereinafter, a unit of management of VDP data on the printing apparatus 100 will be referred to as “a job”. A job analysis unit 202 analyses variable objects, fixed objects, and template data included in the loaded job.

A PostScript (PS) interpreter 203, a PDF interpreter 204, and a Tagged Image File Format (TIFF) decoder 205 rasterize the objects included in the loaded job and convert the rasterized objects into an intermediate data format. A RIP processing unit 206 receives the converted intermediate data format and performs RIP processing to convert the intermediate data format into image data (image).

A cache control unit 207 controls (manages) a cache 208. The cache control unit 207 receives the image data from the RIP processing unit 206 and stores the image data in the cache 208. Upon receipt of inquiry from the job controller 200, the cache control unit 207 searches the cache 208 and transfers image data on objects, if any, to a layout processing unit 209. The cache 208 may be implemented in the RAM 103 or the HDD 104.

The layout processing unit 209 lays out variable data on the variable objects and fixed data on the fixed objects over a page to generate page data based on the template data analyzed by the job analysis unit 202. An image processing unit 210 applies image processing, such as calibration and color conversion, to the page data generated by the layout processing unit 209.

A page data transmission unit 211 stores the page data resulting from the application of the image processing into a page spooler 212, and transmits the stored page data to the printer engine 108 based on an instruction from the job controller 200. The page data transmission unit 211 may directly transmit the page data resulting from the application of the image processing to the printer engine 108. The page spooler 212 may be implemented in the RAM 103 or the HDD 104.

### <Configuration of VDP Data>

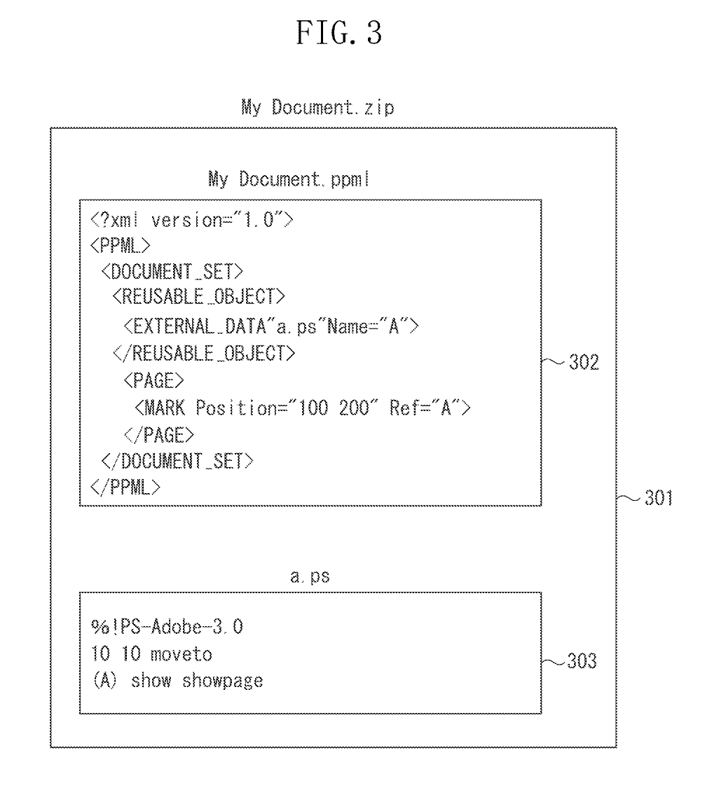

FIG. 3 illustrates an example of the configuration of VDP data (an archive file 301) described in PPML. An example of an archive file 301 is a compressed archive of zip format, including a plurality of files. In the illustrated example, an archive file 301 named “MyDocument.zip” contains a PPML file 302 and a content file 303.

An archive file 301 always contains a PPML file 302. The PPML file 302 is an example of template data. The PPML file 302 defines a plurality of pages for each record that is a variable unit of a job. For example, when print contents vary customer by customer, each customer is handled as a record. More specifically, suppose that a 10-page print job, including variable contents, is intended for 50 customers. In such a case, the job is defined to include 50 records with 10 pages per record.

The PPML file 302 specifies the content file 303 by reference. In the illustrated example, the content file 303 is referred to by the filename “a.ps”. The content file 303 referred to includes an attribute indicating whether a variable object or a fixed object (reusable object). In the illustrated example, the content file 303 is specified to be a reusable object. For description purposes, the illustrated example deals with a case where the archive file 301 contains only one content file 303. An archive file 301 generally includes a plurality of content files 303.

FIG. 3 illustrates a case where the content file 303 is described in PostScript® from Adobe Systems Incorporated. PPML is not limited to PostScript®, and appropriate page description languages (PDLs) may be used. Examples include the PDL languages such as PDF from Adobe Systems Incorporated. General-purpose image formats such as Tagged Image File Format (TIFF) and Joint Photographic Experts Group (JPEG) may be used.

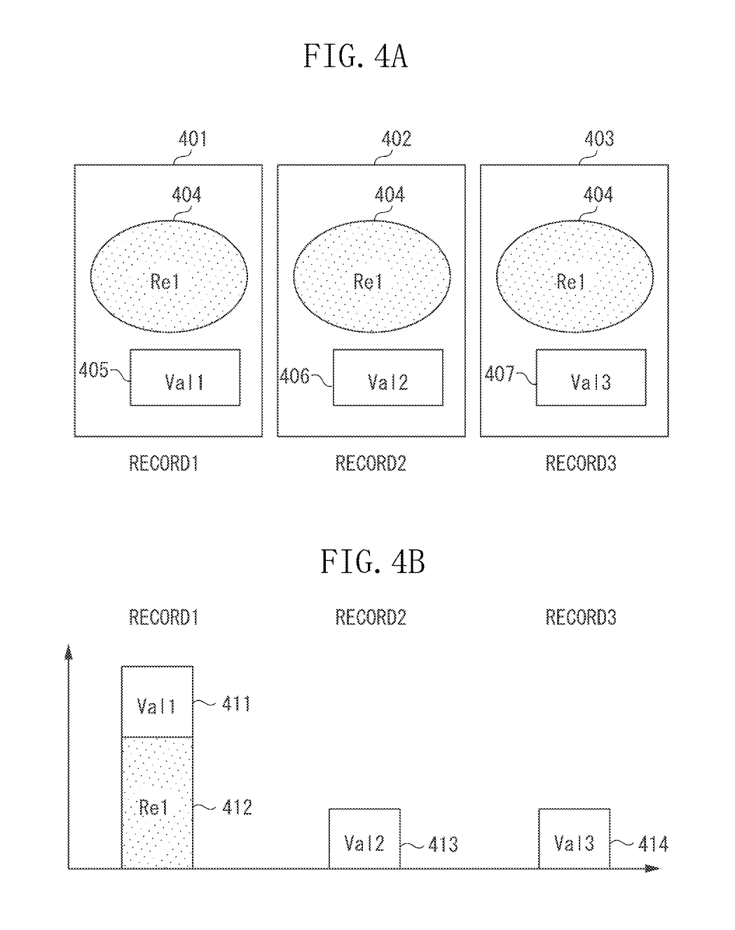

FIG. 4A illustrates an example of print results of a single job. In the illustrated example, a page 401 corresponds to a record 1. A page 402 corresponds to a record 2. A page 403 corresponds to a record 3. FIG. 4A illustrates a print example corresponding to the content file 303 regarding a reusable object Re1 (404). Further, FIG. 4A illustrates print examples corresponding to respective content files (not illustrated) regarding variable objects Val1 (405), Val2 (406), and Val3 (407).

FIG. 4B illustrates an example of RIP processing time of the single job. Suppose that RIP processing is performed in the order of the records 1, 2, and 3. In the record 1, the printing apparatus 100 needs to perform RIP processing on the reusable object Re1 (404).

Accordingly, the RIP processing time for the record 1 is the sum of the RIP processing time 411 of the variable object Val1 (405) and the RIP processing time 412 of the reusable object Re1 (404). It can be seen that a large amount of RIP processing time is needed.

On the other hand, the records 2 and 3 need no RIP processing on the reusable object Re1 (404) since the RIP-processed image data on the reusable object Re1 (404) is already stored in the cache 208. The RIP processing time for the record 2 includes only the RIP processing time 413 of the variable object Val2 (406). The RIP processing time for the record 3 includes only the RIP processing time 414 of the variable object Val3 (407).

### <Print Processing>

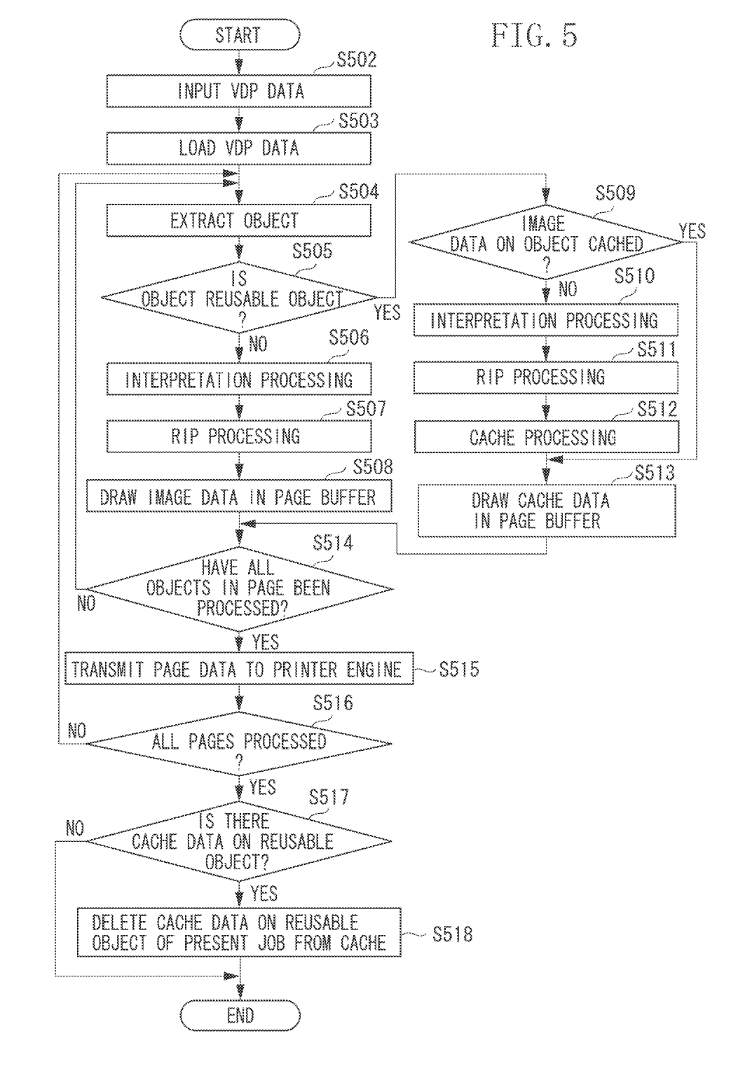

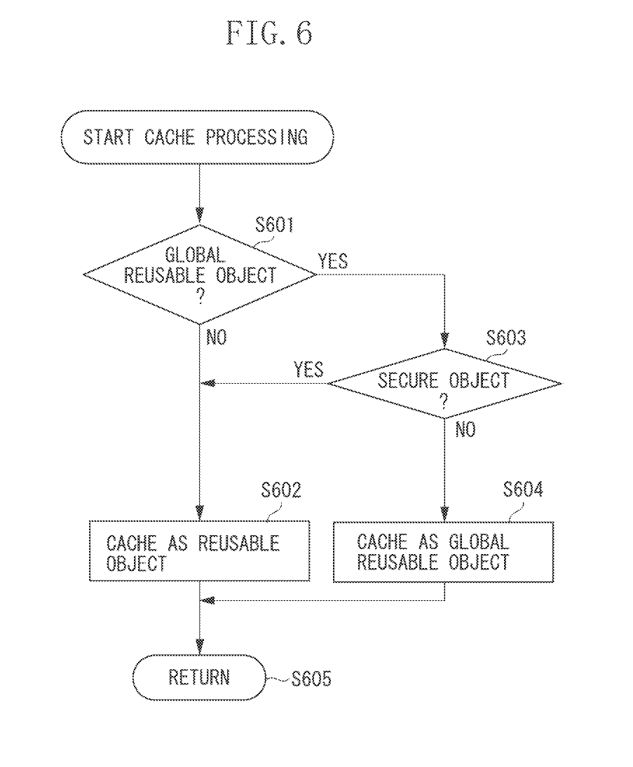

Next, a method for data management of the printing apparatus 100 will be described with reference to flowcharts in FIGS. 5 and 6. FIG. 5 illustrates an example of a flowchart for print processing of the printing apparatus 100. The processing in the flowchart is performed by the software modules (such as the job controller 200), for example. Such software modules may be implemented by the CPU 101 reading programs for the processing in the flowchart, stored in the HDD 104, into the RAM 103 and executing the same.

In step S502, the job controller 200 receives (inputs) VDP data via the network I/F 102. Instep S503, the job loading unit 201 loads the received VDP data into the RAM 103. In step S504, the job analysis unit 202 extracts an object from the loaded VDP data and stores the extracted object into the RAM 103.

In step S505, the job analysis unit 202 determines whether the extracted object is a variable object or a reusable object (including a global reusable object). For example, the job analysis unit 200 makes a determination using identification information that allows object identification. Examples of such identification information include <REUSABLE OBJECT> in FIG. 3, which indicates the attribute of the object included in the VDP data.

For example, a reusable object is an object that can be reused in the present job. A global reusable object is an object that can be reused by other jobs different from the present job.

If the object is determined to be a reusable object (including a global reusable object; YES in step S505), the processing proceeds to step S509. On the other hand, if the object is determined to be a variable object (NO in step S505), the processing proceeds to step S506.

In step S506, the job controller 200 interprets the object. Here, the job controller 200 performs interpretation by the interpretation unit suited to the object among the PS interpreter 203, the PDF interpreter 204, and the TIFF decoder 205.

In step S507, the RIP processing unit 206 generates image data on the object. In step S508, the layout processing unit 209 lays out the generated image data to a specified position, and draws the resultant in a page buffer.

In step S509, the job controller 200 queries the cache control unit 207 and determines whether the image data on the object is stored in the cache 208. If the image data on the object is determined to be stored in the cache 208 (YES in step S509), the processing proceeds to step S513. On the other hand, if the image data on the object is determined not to be stored in the cache 208 (NO in step S509), the processing proceeds to step S510.

In step S510, the job controller 200 interprets the object. The job controller 200 performs interpretation by the interpretation unit suited to the object among the PS interpreter 203, the PDF interpreter 204, and the TIFF decoder 205. In step S511, the RIP processing unit 206 generates image data on the object.

In step S512, the job controller 200 instructs the cache control unit 207 to store the generated image data in the cache 208. The cache processing in step S512 is described below. In step S513, the job controller 200 draws the image data (cache data) on the object stored in the cache 208 in the page buffer.

In step S514, the job controller 200 determines whether all objects constituting the page have been processed. If all the objects are determined to have been processed (YES in step S514), the processing proceeds to step S515. On the other hand, if not all the objects are determined to have been processed (NO in step S514), the processing returns to step S504. In such a manner, the processing is repeated to generate page data (page image).

In step S515, the job controller 200 transmits the generated page data to the page data transmission unit 211, whereby the generated page data is transmitted to the printer engine 108. In step S516, the job controller 200 determines whether all pages have been processed. If all the pages are determined to have been processed (YES in step S516), the processing proceeds to step S517. On the other hand, if not all the pages are determined to have been processed (NO in step S516), the processing returns to step 504 to process the next page.

In step S517, the job controller 200 queries the cache control unit 207 for cache data on a reusable object, and determines whether there is cache data on any reusable object. If the job controller 200 determines that there is cache data on the reusable object (YES in step S517), then in step S518, the job controller 200 causes the cache control unit 207 to delete the cache data on the reusable object. The job controller 200 then ends the job. On the other hand, if the job controller 200 determines that there is no cache data on the reusable object (NO in step S517), the job controller 200 ends the job.

### <Cache Processing>

FIG. 6 illustrates an example of a flowchart for the cache processing. The flowchart in FIG. 6 illustrates the cache processing (S512) in the flowchart illustrated in FIG. 5 in more detail.

In step S601, the job controller 200 determines whether the type of the object of the image data to be stored into the cache 208 is a reusable object or a global reusable object. For example, the job controller 200 refers to scope information (not illustrated) that indicates the effective area of a reusable object included in the VDP data. If the scope information includes a value “GLOBAL”, which represents a global reusable object, the job controller 200 determines that the object is a global reusable object. If the object is determined to be a global reusable object (YES in step S601), the processing proceeds to step S603. On the other hand, if the object is determined to be a reusable object (NO in step S601), the processing proceeds to step S602.

In step S603, the job controller 200 determines whether the global reusable object is a secure object. A secure object refers to data that is under access control (for example, an encrypted PDF file). For example, the job controller 200 makes a determination using a function for determining whether data is under access control. If the object is determined to be a secure object (YES in step S603), the processing proceeds to step S602. On the other hand, if the object is determined not to be a secure object (NO in step S603), the processing proceeds to step S604.

In step S602, the job controller 200 instructs the cache control unit 207 to store the image data on the object in the cache 208 as cache data that represents a reusable object (an example of reusable data that is not reusable by other jobs). For example, if in step S603 the object is determined to be a secure object (YES in step S603), then in step S602, the cache control unit 207 stores the image data on the secure object in the cache 208 as cache data that represents a reusable object.

In step S604, the job controller 200 instructs the cache control unit 207 to store the image data on the global reusable object in the cache 208 as cache data that represents the global reusable object. The cache data that represents the global reusable object is an example of reusable data. The cache data that represents a reusable object and the cache data that represents a global reusable object can be distinguished from each other by an appropriate configuration, such as the addition of a flag.

As described above, if a global reusable object is a secure object, the global reusable object is stored in the cache 208 as the cache data that represents an ordinary reusable object. Since the cache data that represents a reusable object is deleted from the cache 208 at the end of a job, the cache data on the secure object is also deleted at the end of the job. The secure object can thus be prevented from a decrease in the security level. In other words, even if an object under access control is specified to be a global reusable object, such a global reusable object does not remain cached at the end of a job. This can prevent a decrease in security level of an object under access control.

A determination is made in the first exemplary embodiment whether a global reusable object is a secure object. If the global reusable object is determined to be the secure object, image data on the global reusable object is stored in the cache 208 as cache data that represents a reusable object.

In some cases, a user may want to handle a secure object as a global reusable object For example, when high priority is given to printing performance. In a second exemplary embodiment, a method that allows the user to specify how to handle a secure object is discussed. In the second exemplary embodiment, components similar to those of the first exemplary embodiment are designated using the same reference numerals, and thus, the descriptions thereof are omitted where appropriate.

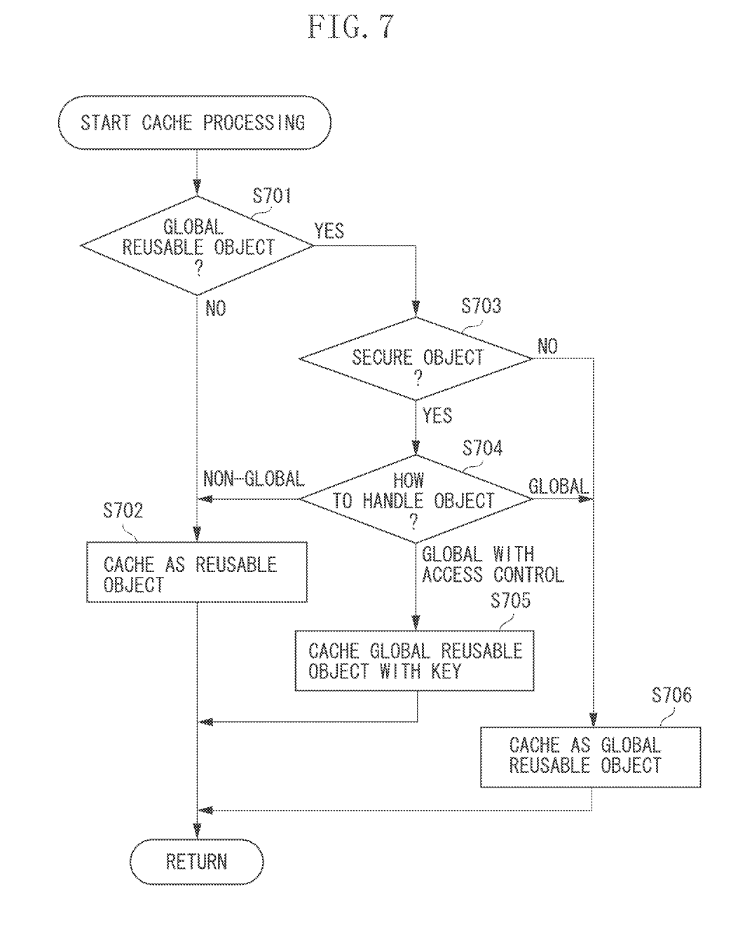

FIG. 7 illustrates an example of a flowchart for cache processing. The flowchart in FIG. 7 illustrates the cache processing (S512) in the flowchart illustrated in FIG. 5 according to the present exemplary embodiment.

In step S701, the job controller 200 determines whether the type of the object of the image data to be cached in the cache 208 is a reusable object or a global reusable object. If the object is determined to be a global reusable object (YES in step S701), the processing proceeds to step S703. On the other hand, if the object is determined to be a reusable object (NO in step S701), the processing proceeds to step S702.

In step S703, the job controller 200 determines whether the global reusable object is a secure object. If the object is determined to be a secure object (YES in step S703), the processing proceeds to step S704. On the other hand, if the object is determined not to be a secure object (NO in step S703), the processing proceeds to step S706.

In step S704, the job controller 200 acquires a setting value for handling the object (an example of setting information) from the HDD 104, and determines how to handle the object. The setting value for the object handling is user-settable information. The setting value can be set via an input device, such as an operation panel, that is arranged on or connected to the printing apparatus 100.

If the object is determined to be handled as a non-global reusable object (NON-GLOBAL in step S704), the processing proceeds to step S702. If the object is determined to be handled as a global reusable object with access control (GLOBAL WITH ACCESS CONTROL in step S704), the processing proceeds to step S705. If the object is determined to be handled as a global reusable object (GLOBAL in step S704), the processing proceeds to step S706.

In step S702, the job controller 200 instructs the cache control unit 207 to store the image data on the object in the cache 208 as cache data that represents a reusable object. For example, if in step S704 the object is determined to be handled as a non-global reusable object (NON-GLOBAL in step S704), then in step S702, the cache control unit 207 stores the image data on the secure object in the cache 208 as the cache data that represents the reusable object.

In step S705, the job controller 200 instructs the cache control unit 207 to store the image data on the global reusable object in the cache 208 as cache data with access control, which represents the global reusable object. The cache data with access control refers to image data on a global reusable object on which the same access control as imposed on the object of VDP data is imposed.

In step S706, the job controller 200 instructs the cache control unit 207 to store the image data on the global reusable object in the cache 208 as cache data that represents the global reusable object.

Since the global reusable object is cached with a key in step S705, the job controller 200, when drawing the cache data in a page buffer in step S513, uses a password to unlock the key, generates image data, and draws the generated image data in the page buffer.

According to the above-described configuration, the printing apparatus 100 can handle even a secure object as a global reusable object for improved printing performance while maintaining the security level thereof according to a user operation on an input device. The printing apparatus 100 can also switch to processing where higher priority is given to printing performance.

The first and second exemplary embodiments do not include the feature of secure print (confidential print). A third exemplary embodiment is provided that describes a method for managing cache data in consideration of printing a job that is related to secure print. In the third exemplary embodiment, components similar to those of the first exemplary embodiment are designated by the same reference numerals, and thus, the descriptions thereof will be omitted where appropriate.

Secure print refers to printing with a mechanism that prevents an output product of data, which is result of a user issuing a print instruction, from being accidentally seen by others. The printing apparatus 100 will not start printing a job related to secure print unless the user issues specific instructions related to secure printing. For example, suppose that a user makes a setting for secure print on data and issues an instruction to print the data. In such a case, the print data includes information indicating the secure print. Based on the information, the printing apparatus 100 treats all objects used in the print data as secure objects.

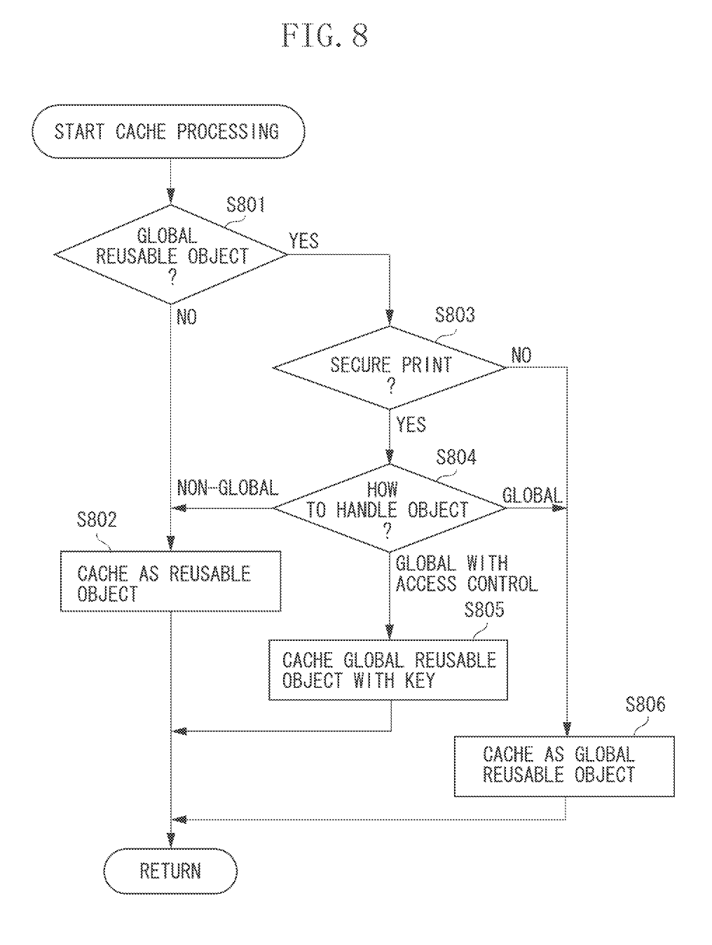

FIG. 8 illustrates an example of a flowchart for cache processing. The flowchart in FIG. 8 illustrates the cache processing (S512) in the flowchart illustrated in FIG. 5.

In step S801, the job controller 200 determines whether the type of the object of the image data to be stored in the cache 208 is a reusable object or a global reusable object. If the object is determined to be a reusable object (NO in step S801), the processing proceeds to step S802. On the other hand, if the object is determined to be a global reusable object (YES in step S801), the processing proceeds to step S803.

In step S803, the job controller 200 determines whether the job is a secure print job. For example, the job controller 200 makes a determination based on information indicating that the secure print is included in the VDP data. If the job is determined to be a secure print job (YES in step S803), the processing proceeds to step S804. On the other hand, if the job is determined not to be a secure print job (NO in step S803), the processing proceeds to step S806.

In step S804, the job controller 200 acquires a setting value for handling the object (an example of setting information) from the HDD 104, and determines how to handle the object. The setting value for the object handling is user-settable information. The setting value can be set via an input device such as an operation panel that is arranged on or connected to the printing apparatus 100.

If the object is determined to be handled as a non-global reusable object (NON-GLOBAL in step S804), the processing proceeds to step S802. If the object is determined to be handled as a global reusable object with access control (GLOBAL WITH ACCESS CONTROL in step S804), the processing proceeds to step S805. If the object is determined to be handled as a global reusable object (GLOBAL in step S804), the processing proceeds to step S806.

In step S802, the job controller 200 instructs the cache control unit 207 to store the image data on the object in the cache 208 as cache data that represents a reusable object. For example, if in step S804 the object is determined to be handled as a non-global reusable object (NON-GLOBAL in step S804), then in step S802, the cache control unit 207 stores the image data on the secure object in the cache 208 as the cache data that represents the reusable object.

In step S805, the job controller 200 instructs the cache control unit 207 to store the image data on the global reusable object in the cache 208 as cache data with access control. The cache data with access control refers to image data on a global reusable object on which the same access control as imposed for the secure print is imposed.

In step S806, the job controller 200 instructs the cache control unit 207 to store the image data on the global reusable object in the cache 208 as cache data that represents the global reusable object.

Since the global reusable object is cached with a key in step S805, the job controller 200, when drawing the cache data in a page buffer in step S513, uses a password to unlock the key, generates image data, and draws the generated image data in the page buffer.

According to the above-described configuration, the printing apparatus 100 can ensure the security of cache data on objects and improve printing performance even when printing a job related to secure print. The printing apparatus 100 can also switch to processing where higher priority is given to printing performance according to a user operation on an input device.

The above-described configurations according to the exemplary embodiments enable more appropriate management of reusable data.

Aspects of the present invention can also be realized by a computer of a system or apparatus (or devices such as a CPU or an MPU) that reads out and executes a program recorded on a memory device to perform the functions of the above-described embodiments, and by a method, the steps of which are performed by a computer of a system or apparatus by, for example, reading out and executing a program recorded on a memory device to perform the functions of the above-described embodiments. For this purpose, the program is provided to the computer for example via a network or from a recording medium of various types serving as the memory device (e.g., computer-readable storage medium).

While the present invention has been described with reference to exemplary embodiments, it is to be understood that the invention is not limited to the disclosed exemplary embodiments. The scope of the following claims is to be accorded the broadest interpretation so as to encompass all modifications, equivalent structures, and functions.

This application claims priority from Japanese Patent Application No. 2011-120508 filed May 30, 2011, which is hereby incorporated by reference herein in its entirety.

What is claimed is:

1. An image forming apparatus, the image forming apparatus comprising:
a memory;
a processor, connected to the memory, the processor configured to determine, while a first job is in process, whether reusable data reusable by a second job different from the first job is under access control, wherein the processor is further configured to, if the reusable data is determined to be under access control, store the reusable data such that it is not reusable by the second job and to store the reusable data such that it is reusable by the second job if the reusable data is determined not to be under access control; and
an image forming unit configured to form an image using the stored reusable data.

2. The image forming apparatus according to claim 1, further comprising a deletion unit configured to delete the reusable data not reusable by the second job when the first job ends.

3. The image forming apparatus according to claim 1, wherein the processor determines handling of the reusable data determined to be under access control according to setting information indicating how to handle the reusable data.

4. The image forming apparatus according to claim 3, wherein if the storing unit determines that the setting information is information indicating that the reusable data under access control is stored into the storage unit as reusable data not reusable by the second job, the storing unit stores the reusable data determined to be under access control into the storage unit as reusable data not reusable by the second job,
wherein the image forming apparatus further comprises a deletion unit configured to delete the reusable data not reusable by the second job from the storage unit when the first job ends.

5. The image forming apparatus according to claim 3, wherein if the setting information indicates that the reusable data under access control is stored with the access control, the processor stores the reusable data determined to be under access control with the access control.

6. The image forming apparatus according to claim 1, wherein the reusable data determined to be under access control is stored with a security key, and wherein a password is used to unlock the security key, which enables generation of image data and drawing of the generated image data.

7. A method for data management executed in an image forming apparatus, the method comprising:
determining, while a first job is in process, whether reusable data reusable by a second job different from the first job is under access control;
storing, if the reusable data is determined to be under access control, the reusable data such that it is not reusable by the second job and storing, if the reusable data is determined not to be under access control, the reusable data such that it is reusable by the second job; and
forming an image using the stored reusable data.

8. The method according to claim 7, further comprising deleting the reusable data not reusable by the second job when the first job ends.

9. The method according to claim 7, further comprising determining handling of the reusable data determined to be under access control according to setting information indicating how to handle the reusable data.

10. The method according to claim 9, further comprising:
if the setting information is determined as information indicating that the reusable data under access control is stored as reusable data not reusable by the second job, storing the reusable data determined to be under access control as reusable data not reusable by the second job; and
deleting the reusable data not reusable by the second job when the first job ends.

11. The method according to claim 9, further comprising, if the setting information is determined as information indicating that the reusable data under access control is stored with the access control, storing the reusable data determined to be under access control with the access control.

12. The method according to claim 7, further comprising storing the reusable data determined to be under access control with a security key, and wherein a password is used to unlock the security key, which enables generation of image data and drawing of the generated image data.

13. A non-transitory computer-readable storage medium storing a program for causing a computer to perform a method for data management, the method comprising:
determining, while a first job is in process, whether reusable data reusable by a second job different from the first job is under access control;
storing, if the reusable data is determined to be under access control, the reusable data such that it is reusable by the second job and storing, if the reusable data is determined not to be under access control, the reusable data such that it is reusable by the second job; and
forming an image using the stored reusable data.
